(19) United States
(12) Patent Application Publication
(10) Pub. No.: US 2026/0228768 A1
(43) Pub. Date: Aug. 6, 2026

(54) SYSTEMS AND METHODS FOR INCREASING ENGAGEMENT

(71) Applicant: Walmart Apollo, LLC, Bentonville, AR (US)

(72) Inventors: Lawrence David Lin, San Francisco, CA (US); Chia-Yen Ho, Cupertino, CA (US); Tianning Dong, Sunnyvale, CA (US); Keerthi Gopalakrishnan, San Jose, CA (US); Yokila Arora, San Jose, CA (US); Tanya Mendiratta, Femont, CA (US); Talha Rehman, Sturbridge, MA (US); Sushant Kumar, San Jose, CA (US); Kannan Achan, Saratoga, CA (US)

(21) Appl. No.: 19/042,767

(22) Filed: Jan. 31, 2025

(51) Int. Cl. G06Q 30/0217; G06Q 30/0207

(52) U.S. Cl. CPC G06Q 30/0218; G06Q 30/0239

(57) ABSTRACT

Example implementations relate to systems and methods for generating customized incentives to increase engagement. In an example, a system receive first data and second data distinct from the first data. The system determines, using a disengagement evaluator, disengagement scores for candidates in the first data, and selects a set of candidates from the first data having disengagement scores above a disengagement threshold to form disengagement candidates. The system determines, using an engagement evaluator, engagement scores for users that are based on the disengagement candidates and the second data, selects a set of the users having engagement scores above an engagement threshold to form engagement candidates. The system generates a notification for a user of the engagement candidates that includes an incentive for user interaction, and transmits the notification to a computing device the user of the engagement candidates.

### TECHNICAL FIELD

This application relates generally to generating incentives, and more particularly, to identifying users that are receptive to receiving incentive and prioritizing users receptive to incentives over less receptive users.

### BACKGROUND

Systems cannot effectively distinguish between users who will convert organically and those who require a strategic nudge to engage with campaigns. This inability leads to wasted resources on users who would convert regardless of nudges or who would be unresponsive to nudges. Existing solutions lack the capability to differentiate between different user segments, creating a critical need for a solution that accurately identifies users for nudging.

### BRIEF DESCRIPTION OF THE DRAWINGS

Various examples will be described below with reference to the following figures.

FIG. 1 depicts an example system for generating incentives, in accordance with some embodiments.

FIG. 2 depicts an example architecture for identifying engagement scores for users, in accordance with some embodiments.

FIG. 3 depicts an example user interface including incentives presented to a user, in accordance with some embodiments.

FIG. 4 depicts a flow diagram for determining user engagement scores and transmitting notifications, in accordance with some embodiments.

FIG. 5 depicts a flow diagram illustrating another method for determining user engagement scores and transmitting notifications, in accordance with some embodiments.

FIG. 6 depicts a flow diagram illustrating a method for training an engagement evaluator, in accordance with some embodiments.

FIG. 7 depicts an example system with a machine-readable medium that includes instructions for determining user engagement scores and transmitting notifications, in accordance with some embodiments.

FIG. 8 depicts an example computer system that implements one or more of the disclosed processes, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor and a non-transitory memory storing instructions, that when executed, cause the processor to perform one or more operations for generating notifications including incentives is disclosed. The instructions, when executed, cause the processor to receive first data and second data distinct from the first data. The instructions, when executed, cause the processor to determine, using a disengagement evaluator, disengagement scores for candidates in the first data. The instructions, when executed, cause the processor to select a set of candidates from the first data having disengagement scores above a disengagement threshold to form disengagement candidates. The instructions, when executed, cause the processor to determine, using an engagement evaluator, engagement scores for users. The engagement scores are based on the disengagement candidates and the second data. The instructions, when executed, cause the processor to select a set of the users having engagement scores above an engagement threshold to form engagement candidates. The instructions, when executed, cause the processor to generate a notification for a user of the engagement candidates. The notification includes an incentive for user interaction. The instructions, when executed, cause the processor to transmit the notification to a computing device associated with the user of the engagement candidates.

In various embodiments, a computer-implemented method for generating notifications including incentives is disclosed. The computer-implemented method includes receiving first data and second data distinct from the first data. The computer-implemented method includes determining, using a disengagement evaluator, disengagement scores for candidates in the first data. The computer-implemented method includes selecting a set of candidates from the first data having disengagement scores above a disengagement threshold to form disengagement candidates. The computer-implemented method includes determining, using an engagement evaluator, engagement scores for users. The engagement scores are based on the disengagement candidates and the second data. The computer-implemented method includes select a set of the users having engagement scores above an engagement threshold to form engagement candidates. The computer-implemented method includes generating a notification for a user of the engagement candidates. The notification includes an incentive for user interaction. The computer-implemented method includes transmitting the notification to a computing device associated with the user of the engagement candidates.

In various embodiments, a non-transitory computer readable medium having instructions for generating notifications including incentives is disclosed. The instructions, when executed by at least one processor, cause the at least one device to perform operations including receiving first data and second data distinct from the first data. The instructions, when executed by at least one processor, cause the at least one device to perform operations including determining, using a disengagement evaluator, disengagement scores for candidates in the first data. The instructions, when executed by at least one processor, cause the at least one device to perform operations including selecting a set of candidates from the first data having disengagement scores above a disengagement threshold to form disengagement candidates. The instructions, when executed by at least one processor, cause the at least one device to perform operations including determining, using an engagement evaluator, engagement scores for users. The engagement scores are based on the disengagement candidates and the second data. The instructions, when executed by at least one processor, cause the at least one device to perform operations including selecting a set of the users having engagement scores above an engagement threshold to form engagement candidates. The instructions, when executed by at least one processor, cause the at least one device to perform operations including generating a notification for a user of the engagement candidates. The notification includes an incentive for user interaction. The instructions, when executed by at least one processor, cause the at least one device to perform operations including transmitting the notification to a computing device associated with the user of the engagement candidates.

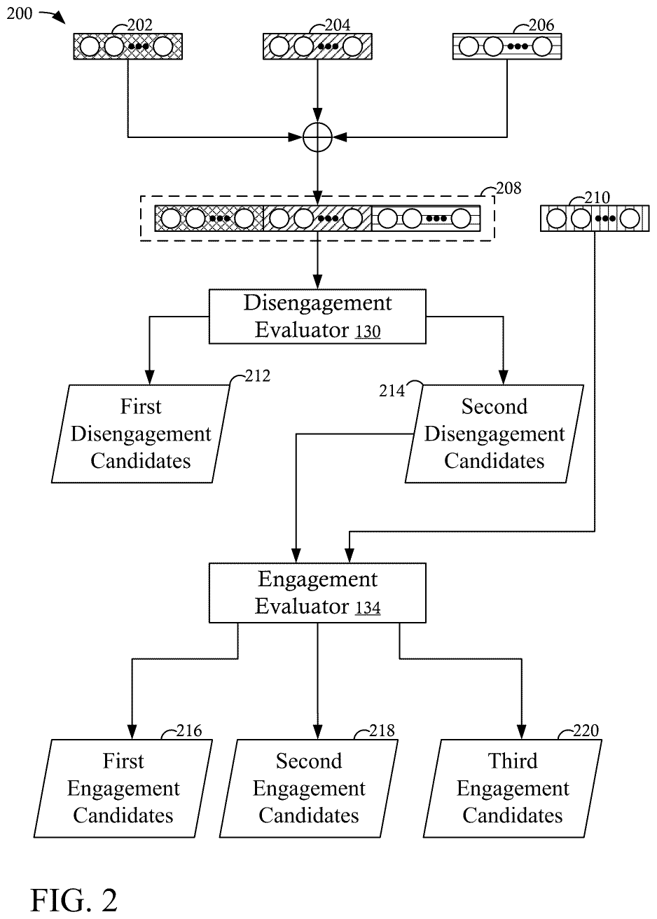

The systems and methods disclosed herein effectively incentivize (or nudge) users by leveraging a value-oriented model to target latent users. The systems and method disclosed herein introduce an incentive generator with a two-stage model framework (e.g., shown in FIG. 2) that generates predictive scores used for precisely targeting users, enhancing campaign effectiveness, and optimizing resources. The first stage of the two-stage model framework (represented by a disengagement evaluator 130; FIG. 2) uses a disengagement model driven engagement prediction layer using a probabilistic model. The second stage of the two-stage model framework (represented by an engagement evaluator 134; FIG. 2) uses a user segmentation engine using a label correction loss function. The second stage aims to identify value-responsive users by determining whether the marketing campaign influences their conversion or if they are likely to convert organically without incentives.

The systems and methods disclosed herein use an adaptive multiclass neural network for reactivation and retention. The adaptive multiclass neural network framework introduces a new approach by operating directly at the self-cancellation interface, providing real-time predictions and personalized interventions. The systems and methods disclosed herein generate proactive interventions before engagement decay. This allows for intervention on persuadable users before they reach point of no return. The systems and methods disclosed herein use a dual optimization framework integrating disengagement propensity and value-oriented latent user segmentation. The systems and methods disclosed herein provide a label correction strategy in semi-supervised learning, which iteratively updates and corrects labels using a student teacher model for users whose responses to marketing campaigns are unknown. Student teacher model enhances predictive accuracy. The systems and methods disclosed herein optimize marketing campaigns by accurately identifying which users are likely to convert without incentives and which require incentive for engagement and conversion.

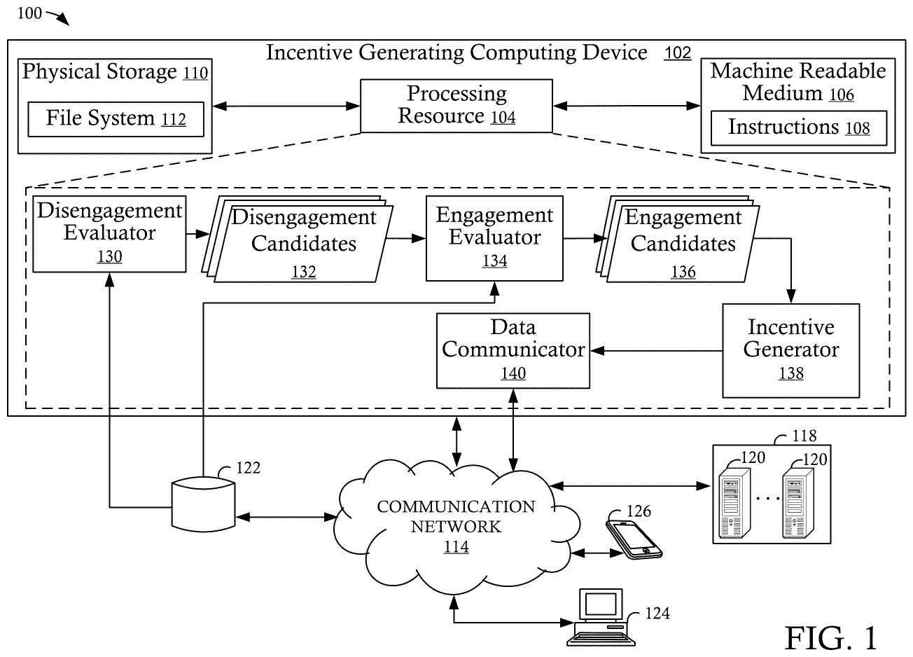

FIG. 1 depicts an example system for generating incentives, in accordance with some embodiments. The system 100 includes an incentive generating computing device 102 that identifies users receptive to receiving incentives which further increase engagement. The incentive generating computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The incentive generating computing device 102 includes a non-transitory machine readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the incentive generating computing device 102, such as using a disengagement evaluator 130 for determining disengagement candidates 132 and/or an engagement evaluator 134 for determining engagement candidates 136. The instructions 108 may include instructions for implementing one or more models. In some embodiments, and as will be described further herein below, the incentive generating computing device 102 may execute one or more models, processes, or algorithms, such as a machine learning model, deep learning model, statistical model, etc., (e.g., as implemented as machine readable instructions), such as the disengagement evaluator 130, the engagement evaluator 134, and an incentive generator 138 to determine engagement candidates to be contacted via one or more messages and/or notifications.

The incentive generating computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the incentive generating computing device 102. In some implementations, physical storage 110 may be accessed as a block storage device.

In some cases, the incentive generating computing device 102 may also include a local file system 112 that may be implemented as a layer on top of the physical storage 110. For example, an operating system 112 may be executing on the incentive generating computing device 102 (by virtue of the processing resource 104 executing certain instructions 108 related to the operating system) and the operating system 112 may provide a file system 112 to store data on the physical storage 110.

The network 114 may include a plurality of devices or systems in communication with the incentive generating computing device 102 over one or more network channels, illustrated as a network cloud. For example, in various embodiments, the incentive generating computing device 102 may be in communication with a web server 116, a cloud-based engine 118 including one or more processing devices 120 that may be provisioned for use, one or more databases (e.g., database 122), a workstation 124, and/or any other suitable system or device. The incentive generating computing device 102 may similarly be in communication, either directly or indirectly, with one or more user computing devices 126 operatively coupled over the network 114. The other computing systems may be similar to the incentive generating computing device 102, and may each include at least a processing resource and a machine readable medium.

The disengagement evaluator 130 receives first data (e.g., input features) from the database 122. Non-limiting examples, the first data include engagement data, interaction data (or transaction data), and profile data. For example, in some embodiments, the disengagement evaluator 130 can receive transaction features, user profile or behavioral features, and/or benefit engagement features. Any number of features can be used by the disengagement evaluator 130. The disengagement evaluator 130 determines disengagement scores for candidates in the first data. Candidates include one or more users in the first data evaluated for disengagement. For example, candidates can be one or more users with measurable disengagement scores. The disengagement evaluator 130 selects a set of candidates from the first data having disengagement scores above a disengagement threshold to form disengagement candidates 132. In some embodiments, the disengagement candidates 132 include one or more of candidate interactions, candidate engagements, or candidate users. As discussed below in reference to FIG. 2, the disengagement evaluator 130 can form a plurality of disengagement candidates.

The engagement evaluator 134 receives the disengagement candidates 132 and second data (e.g., user data, such as user input features) from the database 122. Non-limiting examples of the user data can include membership data, demographics data, operational satisfaction data, and/or engagement data. The engagement evaluator 134 determines engagement scores for users based on the disengagement candidates and the second data, and select a set of the users having engagement scores above an engagement threshold to form engagement candidates. In some embodiments, the engagement evaluator 134 evaluates the engagement scores for users using a plurality of engagement threshold to form a plurality of engagement candidates. For example, the engagement evaluator 134 can select a first set of the users having engagement scores above a first engagement threshold to form first engagement candidates and select a second set of the users having engagement scores above a second engagement threshold to form second engagement candidates, the second engagement threshold being less than the first engagement threshold.

In some embodiments, the engagement evaluator 134 is trained via a semi-supervised label correction method, which provides a solution to a missing label problem (e.g., missing the labels of the counterfactual from the real-world data) by implementing meta-pseudo-labeling to the data. To this end the engagement evaluator 134 can include a first segment (e.g., a teacher component) and a second segment (e.g., a student component). The teacher component infers second engagement candidates (e.g., “organic converters”) from users whose engagement would increase when provided an incentive. The inferred second engagement candidates (or other inferences made by the teacher component) are used to train the student component. The student component calculates a loss that is provided to the teacher component to update the teacher component.

As an example, the training the engagement evaluator 134 includes providing test data to the first segment of the engagement evaluator 134 and determining, by the first segment of the engagement evaluator 134, based on the test data a first set of test users satisfying a first engagement threshold, a second set of test users satisfying a second engagement threshold. The first set of test users and the second set of test users form inferred test data. Training the engagement evaluator 134 can further include providing the inferred test data to the second segment of the engagement evaluator, determining, by the second segment of the engagement evaluator, a loss based on the inferred test data, and updating the first segment of the engagement evaluator using the loss.

The incentive generator 138 receives the engagement candidates and generates notification for a set of users of the engagement candidates. The notifications include incentive for user interaction (e.g., incentives for increasing user engagement). In some embodiments, the incentive generator 138 may forgo generating notifications for another set of users of the engagement candidates, as discussed below in reference to FIG. 2. The incentives included in the notifications are personalized for each user. The notifications can be presented at different computing devices, webpages hosted by a server, workstations, etc. The notifications can be presented as messages, user interface elements, advertisements, coupons, etc.

The data communicator 140 receives the notifications generated by the incentive generator 138 and transmits the notification to a computing device associated with the user of the engagement candidates. For example, the notification can be transmitted to a user's computing device 126, a server hosting a webpage frequented by the user, applications running on a user's computing device, user interfaces presented at the computing device, etc. In some embodiments, transmitting the notification to the computing device associated with the user of the engagement candidates includes causing the computing device to present a first user interface element for interacting with the incentive, and a second user interface element for requesting an additional incentive.

In some embodiments, training data is generated for one or more models (e.g., machine learning models, deep learning models, statistical models, algorithms, etc.) based on the data and/or input features, etc. One or more models are trained based on corresponding training data. The trained models may be stored in a database, such as in the database 122 (or a cloud storage database).

The models, when executed by the incentive generating computing device 102, allow the incentive generating computing device 102 to detect candidate likely to engage with generated incentives. For example, the incentive generating computing device 102 may obtain one or more models from the database 122. The incentive generating computing device 102 may then receive, in real-time, the disengagement candidates 132 and/or input features. In response to receiving the disengagement candidates 132 and/or input features, the incentive generating computing device 102 may execute one or more models to determine engagement candidates likely to interact with incentives.

In some embodiments, the incentive generating computing device 102 assigns the models (or parts thereof) for execution to one or more processing devices 120. For example, each model may be assigned to a virtual machine hosted by a processing device 122. The virtual machine may cause the models or parts thereof to execute on one or more processing units such as GPUs. In some embodiments, the virtual machines assign each model (or part thereof) among a plurality of processing units. Based on the output of the models, incentive generating computing device 102 may determine disengagement candidates and engagement candidates.

FIG. 2 depicts an example system architecture for identifying engagement scores for users, in accordance with some embodiments. The system architecture 200 is analogous to the incentive generating computing device 102 of FIG. 1. For example, the system architecture 200 includes at least a disengagement evaluator 130 and an engagement evaluator 134. The disengagement evaluator 130 and the engagement evaluator 134 receive first data 208 and second data 210. The first data 208 and second data 210 can be input features for the disengagement evaluator 130 and the engagement evaluator 134.

The system architecture 200 depicts a two-stage framework that precisely targets latent users that are receptive to incentives. A first stage of the two-stage framework (e.g., represented by at least the disengagement evaluator 130) uses a disengagement propensity model to predict user engagement by deeply analyzing user behavior patterns and transaction trends (e.g., purchasing trends), identifying high-value users at risk of disengagement. A second stage of the two-stage framework uses an output of the first stage and feeds them into at least the engagement evaluator 134 (e.g., a multi-class neural network using a self-correcting label strategy). The engagement evaluator 134 extracts counterfactual labels from real-world data by partitioning users into test and control groups, training models to learn from organic converters, and mapping campaign-exposed users to these behaviors. The system architecture 200 filters out users who would convert regardless of intervention.

The first data 208 can be a combination of one or more features. For example, the first data 208 can be combination of a first feature set 202, a second feature set 204, and a third feature set 206. The first data 208 can be a combination of any number of feature sets. In some embodiments, the first feature set 202 includes features based on user profiles or user understanding data, the second feature set 204 includes features based on engagement data, and a third feature set 206 includes features based on interactions and/or transactions. Transaction features can include fulfilment channels (e.g., shipping, pickup, delivery), customer spend, inter-purchase intervals, order frequency, etc. The benefit engagement features include usage frequency, recency, scan and go, etc. The user understanding features can include features based on user history, user interactions, user engagement, user interest, user dislikes, etc.

The second data 210 can include user data, such as membership features, demographics features, operational satisfaction features and/or any other features. Membership features can include a membership tenure, a membership plan, and/or membership management. Demographics features include gender, family size, occupation, income, home ownership (e.g., owner or renter), mortgage, and/or time zones. The operational satisfaction features include nil picks (e.g., unfound items), substituted items, customer contacts, returns, cancels, and/or fulfillment speed. In some embodiments, the use data include high value user features (e.g., features of candidate users for engagement).

The above-examples are non-limiting and different feature sets can be included in the first data 208 or the second data 210.

The first data 208 is provided to the disengagement evaluator 130. The disengagement evaluator 130 predict a propensity of users to disengage and/or distinguishing between active users and inactive users. The disengagement evaluator 130 may be a multi-class classification model, which can be driven by multiple classes of models like XGBoost, neural network, etc. As described above in reference to FIG. 1, the disengagement evaluator 130 determines one or more sets of disengagement candidate. For example, the disengagement evaluator 130 can determine first disengagement candidates 212 and second disengagement candidates 214. For example, the disengagement evaluator 130 can select a first set of candidates from the first data having disengagement scores above a first disengagement threshold to form the first disengagement candidates 212 and select a second set of candidates from the first data having disengagement scores above a second disengagement threshold to form the second disengagement candidates 214. The first disengagement candidates 212 can be candidates that have a high propensity to disengage. For example, the first disengagement candidates 212 can identify at least candidates with low transactions and low engagement. Alternatively, the second disengagement candidates 214 can be candidates that have a low propensity to disengage. For example, the second disengagement candidates 214 can identify at least candidates' high transaction and high engagement.

The second disengagement candidates 214 and the second data 210 are provided to the engagement evaluator 134. In some embodiments, the engagement evaluator 134 is a user segmentation engine. The engagement evaluator 134 may identify value-responsive users by determining whether the marketing campaign influences their conversion or if they are likely to convert organically without an incentive. The engagement evaluator 134 can be a multiclass neural architecture with self-training label correction strategy. As described above in reference to FIG. 1, the engagement evaluator 134 determines one or more sets of engagement candidate. For example, the engagement evaluator 134 can determine first engagement candidates 216, second engagement candidates 218, and third engagement candidates 220. For example, the engagement evaluator 134 can select a first set of users having engagement scores (e.g., determined based at least on the second data 210 and the second disengagement candidates 214) above a first engagement threshold to form the first engagement candidates 216, select a second set of the users having engagement scores above a second engagement threshold to form the second engagement candidates 218, and select a third set of the users having engagement scores above a third engagement threshold to form the third engagement candidates 220. The first engagement candidates 216 are candidates that are likely to convert in response to an incentive. The second engagement candidates 218 are candidates that are likely to convert organically (e.g., without incentives). The third engagement candidates 220 are candidates that are not likely to convert organically or with incentives.

The two-stage objective function described above is defined by the following:

$$L = {\sum }_{i = 1}^{N} {y}_{i} {L}_{i}^{+} + ( 1 - {y}_{i} ) {L}_{i}^{-} , where \qquad ( 1 )$$

$${L}_{i}^{+} = log ( {p}_{i} ) , if {p}_{i} > τ , {L}_{i}^{+} = log ( 1 - {p}_{i} ) otherwise \qquad ( 2 )$$

$${L}_{i}^{-} = log ( 1 - {p}_{i} ) \qquad ( 3 )$$

N denotes the number of users, yᵢ denotes the true label for the i-th user, pᵢ denotes the predicted probability of the i-th user being in the positive class, τ denotes a threshold to identify whether it is a true positive or false positive based on the model prediction probability, and

$${L}_{i}^{+} and {L}_{i}^{-}$$

denote the positive and negative losses of the i-th user. This objective function helps correct false positives by flipping the positive loss when model predicted probability is low.

An incentive generator 138 (FIG. 1) in response to receiving the first engagement candidates 216 generates respective notifications including incentives for the users within the first engagement candidates 216. Alternatively, the incentive generator 138 in response to receiving the second engagement candidates 218 and the third engagement candidates 220 forgoes generating notification (e.g., as the users of the second engagement candidates 218 and the third engagement candidates 220 are likely to convert on their own or not at all).

The system architecture 200 aims to understand users' intentions in interaction and conversion, as well as the users' valuation of items, products, services, etc. The system architecture 200, as descried above, can generate distinct user segments. In some embodiments, the system architecture 200 generates at least four segments. For example, the four segments can include organic converters (e.g., the second engagement candidates 218), persuadable users (e.g. the first engagement candidates 216), unpersuadable users (e.g., the third engagement candidates 220), and disengaged users (e.g., first disengagement candidates 212). In some embodiments, systems and methods disclosed herein determine that persuadable users should receive incentives and other user sets should not receive incentives.

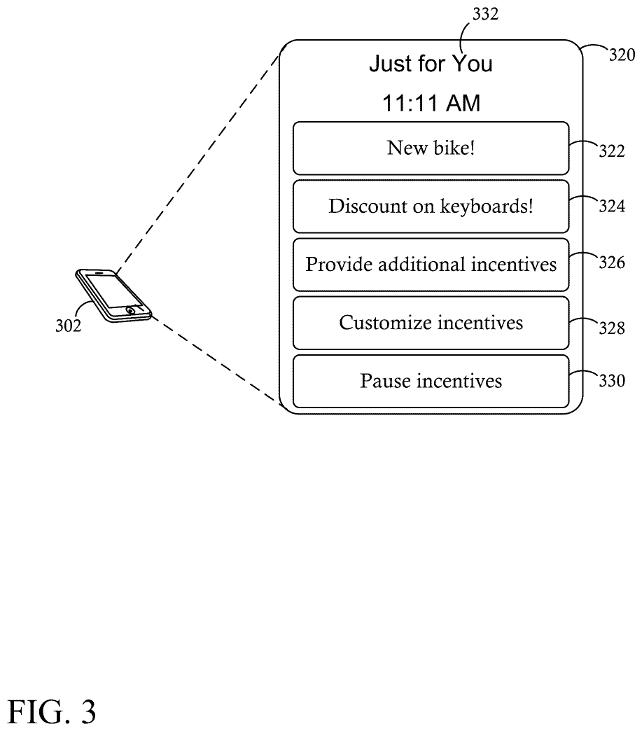

FIG. 3 depicts an example user interface including incentives presented to a user, in accordance with some embodiments. A computing device 302 associated with a user (selected from engagement candidates) receives a notification that includes one or more incentives for the user. The notification can cause the computing device to present a first user interface element for interacting with the incentive, and a second user interface element for requesting an additional incentive. For example, as shown in FIG. 3, the computing device 302 presents a user interface 320 including one or more user interface elements (e.g., first through fifth user interface elements 322, 324, 326, 328, and 330) and/or incentive dialogue 332. Each of the one or more user interface elements and incentive dialogue 332 include incentives for increasing user engagement. Each of the one or more user interface elements allows the user to engage with the presented incentives, customize the incentives, request additional incentives, and/or pause the incentives.

In some embodiments, the incentives are presented to users on websites or applications hosted by a server. For example, the generated notifications including incentives can be presented on a splash page, homepage banner, purchase history banner, etc. The generated notifications including incentives can be presented on messages, emails, application, phone notifications, etc. The above examples are non-limiting; and the generated notifications can be presented to the user through different communication channels.

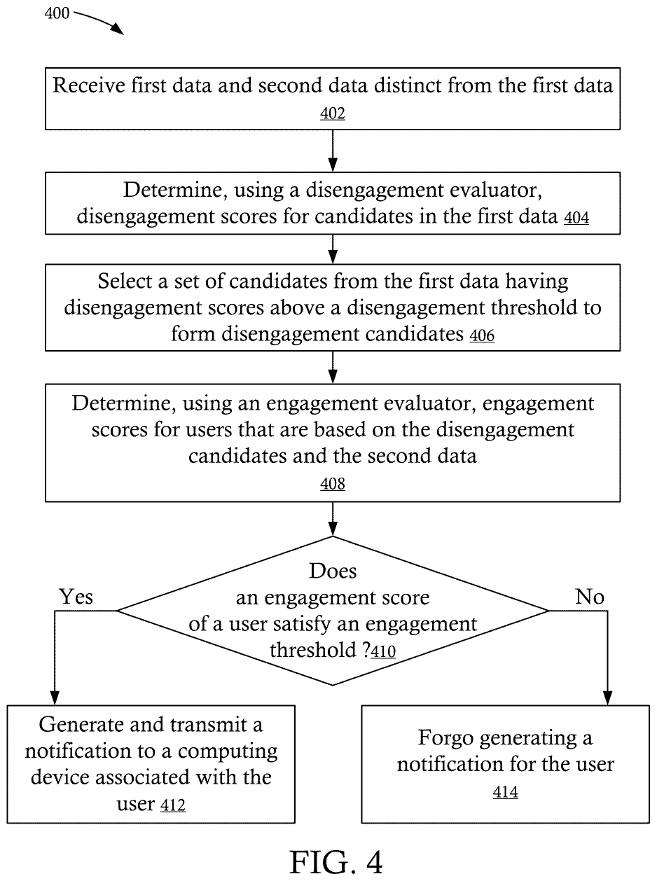

FIGS. 4-6 depict example methods for detecting disengagement and generating messages for reducing or preventing disengagement (e.g., disengagement prevention incentives), in accordance with some embodiments. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The methods shown in FIGS. 4-6 may be implemented in the form of executable instructions stored on machine-readable media and executed by a processing resource and/or in the form of electronic circuitry. For example, aspects of the methods may be described below as being performed by an incentive generating computing device 102, an example of which may be a disengagement evaluator 130, an engagement evaluator 134, an incentive generator 138, etc. running on a hardware processing resource 104 of the incentive generating computing device 102 described above in reference to FIG. 1. Additionally, other aspects of the methods described below may be described with reference to other elements shown in FIG. 1 for non-limiting illustration purposes.

FIG. 4 depicts a flow diagram for determining user engagement scores and transmitting notifications, in accordance with some embodiments. The method 400 includes receiving (402) first data and second data distinct from the first data. The method 400 includes determining (404), using a disengagement evaluator, disengagement scores for candidates in the first data, and selecting (406) a set of candidates from the first data having disengagement scores above a disengagement threshold to form disengagement candidates. The method 400 further includes determining (408), using an engagement evaluator, engagement scores for users. The engagement scores are based on the disengagement candidates and the second data.

The method 400 further include determining (410) whether an engagement score of a user satisfies an engagement threshold. The method 400 includes, in accordance with a determination that the engagement score of the user satisfies the engagement threshold (“Yes” at operation 410), generating (412) and transmitting a notification to a computing device associated with the user. Alternatively, the method 400 further includes, in accordance with a determination that the engagement score of the user does not satisfy the engagement threshold (“No” at operation 410), forgoing (414) generating a notification for the user.

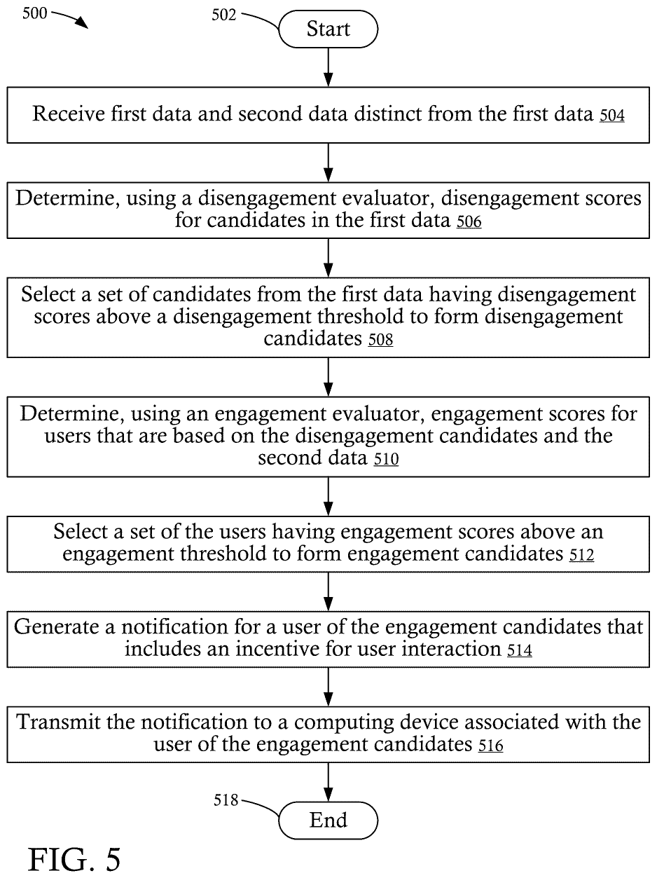

FIG. 5 depicts a flow diagram illustrating another method for determining user engagement scores and transmitting notifications, in accordance with some embodiments. The method 500 starts at operations (502) and proceeds to operation (504). At operation (504), the method 500 includes receiving first data and second data distinct from the first data. The method 500 proceeds to operation (506). At operation (506), the method includes determining, using a disengagement evaluator, disengagement scores for candidates in the first data. The method 500, at operation (508), includes selecting a set of candidates from the first data having disengagement scores above a disengagement threshold to form disengagement candidates.

The method 500 then proceeds to operation (510), which includes determining, using an engagement evaluator, engagement scores for users that are based on the disengagement candidates and the second data. The method 500, at operation (512), includes selecting a set of the users having engagement scores above an engagement threshold to form engagement candidates. The method 500 includes operation (514). At operation (514), the method 500 includes generating a notification for a user of the engagement candidates that includes an incentive for user interaction. The method 500 further includes operation (516), in which the method 500 includes transmitting the notification to a computing device associated with the user of the engagement candidates. The method 500 ends at operation (518).

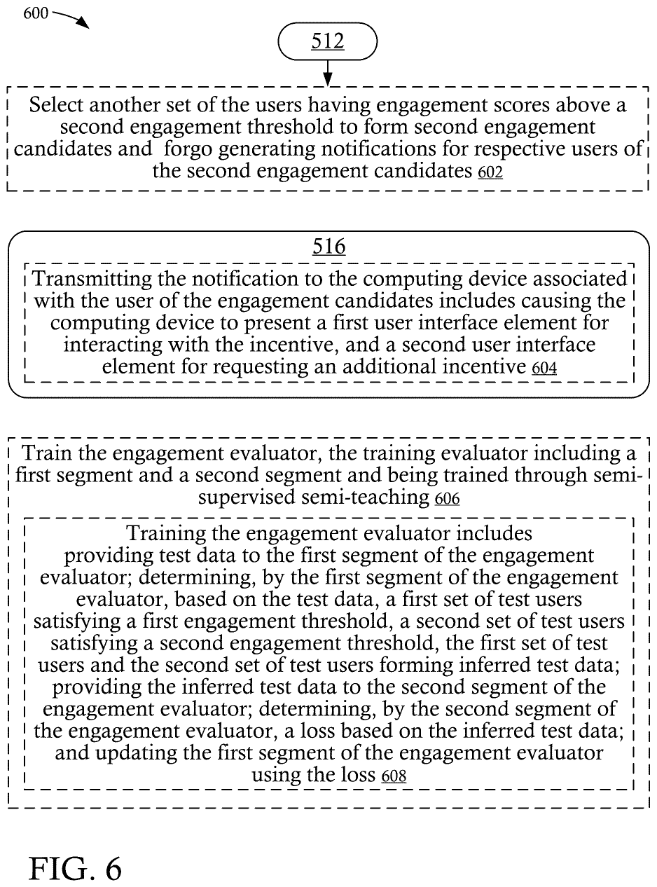

FIG. 6 depicts a flow diagram illustrating a method for training an engagement evaluator, in accordance with some embodiments. The method 600 includes one or more operations that run in conjunction with, before, and/or after one or more operations of method 500. As indicated above, in some embodiments, one or more blocks of the methods may be executed substantially concurrently and/or in a different order than shown.

In some embodiments, the method 600 includes operation (602), which expands on method 500 (e.g., performed after operation (512)). Operation (602) includes selecting another set of the users having engagement scores above a second engagement threshold to form second engagement candidates, and forgoing generating notifications for respective users of the second engagement candidates. The method 600 includes operation (604), which also expands on method 500 (e.g., expanding on operation (516)). Operation (604) includes transmitting the notification to the computing device associated with the user of the engagement candidates includes causing the computing device to present a first user interface element for interacting with the incentive, and a second user interface element for requesting an additional incentive.

In some embodiments, the method 600 includes operations (606) and (608). Operation (606) includes training the engagement evaluator, the training evaluator including a first segment and a second segment and being trained through semi-supervised semi-teaching. Operation (608) further includes providing test data to the first segment of the engagement evaluator; determining, by the first segment of the engagement evaluator, based on the test data, a first set of test users satisfying a first engagement threshold, a second set of test users satisfying a second engagement threshold, the first set of test users and the second set of test users forming inferred test data; providing the inferred test data to the second segment of the engagement evaluator; determining, by the second segment of the engagement evaluator, a loss based on the inferred test data; and updating the first segment of the engagement evaluator using the loss.

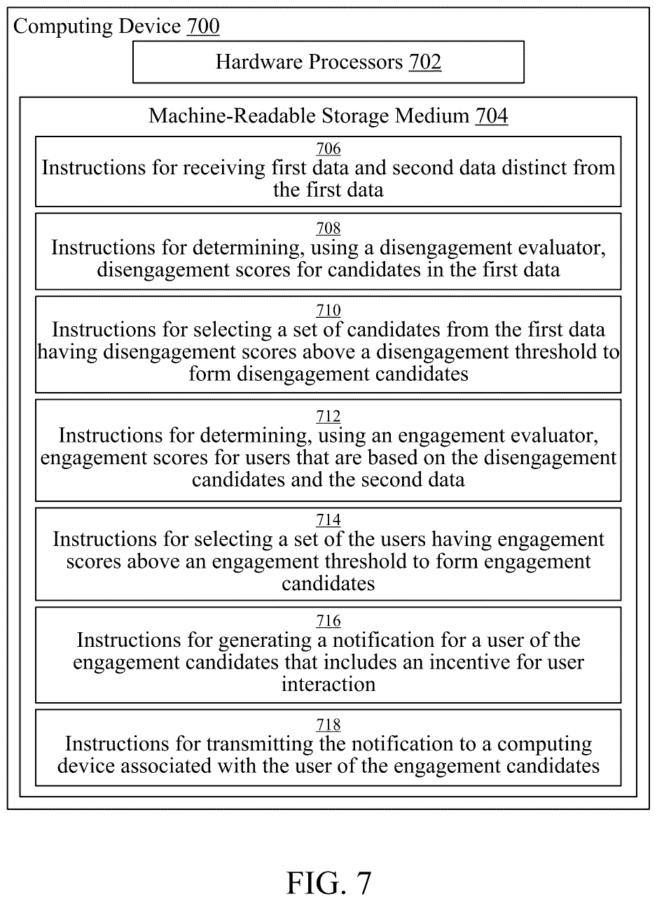

FIG. 7 depicts an example system 700 that includes non-transitory, machine-readable media 704 encoded with example instructions executable by processing resource 702. In some implementations, the system 700 may be useful for implementing aspects of the incentive generating computing device 102 of FIG. 1 and analogous systems (e.g., disengagement detection and reduction system 200; FIG. 2). For example, the instructions encoded on machine-readable media 704 may be included in instructions 108 of FIG. 1. In some implementations, functionality described with respect to FIG. 1 may be included in the instructions encoded on machine-readable media 704.

The processing resource 702 may include a microcontroller, a microprocessor, central processing unit core(s), an ASIC, an FPGA, and/or other hardware device suitable for retrieval and/or execution of instructions from the machine-readable media 704 to perform functions related to various examples. Additionally or alternatively, the processing resource 702 may include or be coupled to electronic circuitry or dedicated logic for performing some or all of the functionality of the instructions described herein.

The machine-readable media 704 may be any medium suitable for storing executable instructions, such as RAM, ROM, EEPROM, flash memory, a hard disk drive, an optical disc, or the like. In some example implementations, the machine-readable media 704 may be a tangible, non-transitory medium. The machine-readable media 704 may be disposed within the system 700 respectively, in which case the executable instructions may be deemed installed or embedded on the system. Alternatively, the machine-readable media 704 may be a portable (e.g., external) storage medium, and may be part of an installation package.

As described further herein below, the machine-readable media 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 7.

With reference to FIG. 7, the machine-readable media 704 includes instructions 706-718. Instructions 706, when executed, cause the processing resource 702 to receive first data and second data distinct from the first data. Instructions 708, when executed, cause the processing resource 702 to determine, using a disengagement evaluator, disengagement scores for candidates in the first data. Instructions 710, when executed, cause the processing resource 702 to select a set of candidates from the first data having disengagement scores above a disengagement threshold to form disengagement candidates. Instructions 712, when executed, cause the processing resource 702 to determine, using an engagement evaluator, engagement scores for users that are based on the disengagement candidates and the second data. Instructions 714, when executed, cause the processing resource 702 to select a set of the users having engagement scores above an engagement threshold to form engagement candidates. Instructions 716, when executed, cause the processing resource 702 to generate a notification for a user of the engagement candidates that includes an incentive for user interaction. Instructions 718, when executed, cause the processing resource 702 to transmit the notification to a computing device associated with the user of the engagement candidates.

In some embodiments, training data is generated for one or more models (e.g., machine learning models, deep learning models, statistical models, algorithms, etc.) based on historical data and features described above in reference to FIGS. 1 and 2. One or more models are trained based on corresponding training data. The trained models may be stored in a database, such as in a database (e.g., a cloud storage database).

The models, when executed by the incentive generating computing device 102, allow the incentive generating computing device 102 to detect users at risk of disengagement and/or receptive for receiving incentives and generating incentives that are transmitted to users to increase engagement. For example, the incentive generating computing device 102, in response to receiving data may execute one or more models to determine users that are receptive to receiving incentives for increasing engagement and transmit personalized incentives to the identified users. A user computing device 126 may then receive the personalized incentive and engage with the incentive.

In some embodiments, the incentive generating computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, the incentive generating computing device 102 may generate personalized incentives for users identified as likely to engage with incentives.

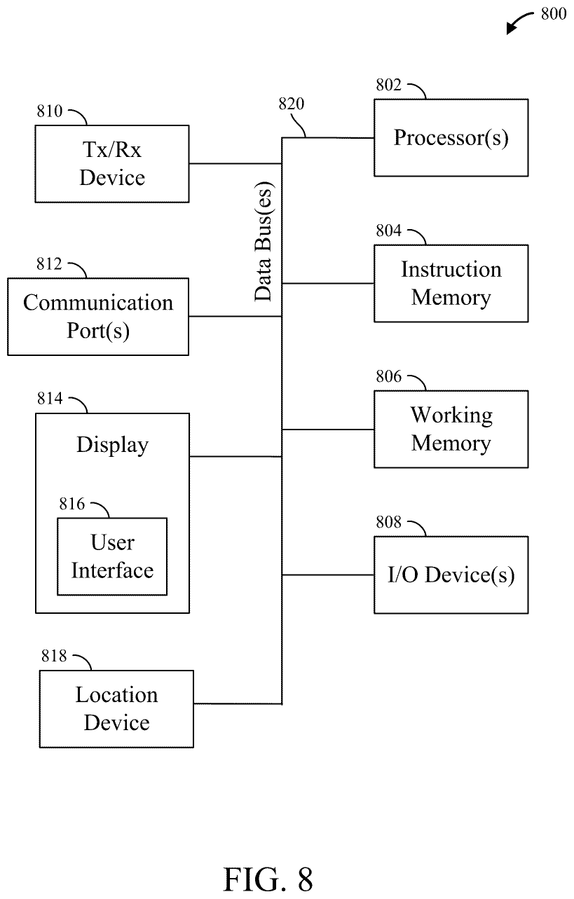

FIG. 8 illustrates a block diagram of a computing device 800, in accordance with some embodiments. Although FIG. 8 is described with respect to certain components shown therein, it will be appreciated that the elements of the computing device 800 may be combined, omitted, and/or replicated. In addition, it will be appreciated that additional elements other than those illustrated in FIG. 8 may be added to the computing device.

As shown in FIG. 8, the computing device 800 may include one or more processing resources 802, instruction memory 804, working memory 806, input/output devices 808, transceiver 810, communication ports 812, display 814, optional location device 818, and/or any other suitable elements each operatively coupled to one or more data buses 820. The data buses 820 allow for communication among the various components. The data buses 820 may include wired, or wireless, communication channels.

The one or more processing resources 802 may include any processing circuitry operable to control operations of the computing device 800. In some embodiments, the one or more processing resources 802 include one or more distinct processors, each having one or more cores (e.g., processing circuits). Each of the distinct processors may have the same or different structure. The one or more processing resources 802 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 802 may also be implemented by a controller, a microcontroller, an application specific integrated circuit (ASIC), a field programmable gate array (FPGA), a programmable logic device (PLD), etc.

In some embodiments, the one or more processing resources 802 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 804 may store instructions that are accessed (e.g., read) and executed by at least one of the one or more processing resources 802. For example, the instruction memory 804 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 802 may perform a certain function or operation by executing code, stored on the instruction memory 804, embodying the function or operation. For example, the one or more processing resources 802 may execute code stored in the instruction memory 804 to perform one or more of any function, method, or operation disclosed herein.

Additionally, the one or more processing resources 802 may store data to, and read data from, the working memory 806. For example, the one or more processing resources 802 may store a working set of instructions to the working memory 806, such as instructions loaded from the instruction memory 804. The one or more processing resources 802 may also use the working memory 806 to store dynamic data created during one or more operations. The working memory 806 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 804 and working memory 806, it will be appreciated that the computing device 800 may include a single memory unit that operates as both instruction memory and working memory. Further, although embodiments are discussed herein including non-volatile memory, it will be appreciated that computing device 800 may include volatile memory components in addition to at least one non-volatile memory component.

In some embodiments, the instruction memory 804 and/or the working memory 806 includes an instruction set, in the form of a file for executing various methods, such as methods for detecting disengagement and generating disengagement prevention incentives, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 802.

The input/output devices 808 may include any suitable device that allows for data input or output. For example, the input/output devices 808 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 810 and/or the communication port(s) 812 allow for communication with a network. For example, if a communication network is a cellular network, the transceiver 810 allows communications with the cellular network. In some embodiments, the transceiver 810 is selected based on the type of the communication network the computing device 800 will be operating in. The one or more processing resources 802 are operable to receive data from, or send data to, a network, via the transceiver 810.

The communication port(s) 812 may include any suitable hardware, software, and/or combination of hardware and software that is capable of coupling the computing device 800 to one or more networks and/or additional devices. The communication port(s) 812 may be arranged to operate with any suitable technique for controlling information signals using a desired set of communications protocols, services, or operating procedures. The communication port(s) 812 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 812 allows for the programming of executable instructions in the instruction memory 804. In some embodiments, the communication port(s) 812 allow for the transfer (e.g., uploading or downloading) of data, such as machine learning model training data.

In some embodiments, the communication port(s) 812 couples the computing device 800 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 810 and/or the communication port(s) 812 utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 814 may be any suitable display, and may display the user interface 816. The user interfaces 816 may enable user interaction with a disengagement detection and reduction system. For example, the user interface 816 may be a user interface for an application of a network environment operator that allows a user to view and interact with the operator's website. In some embodiments, a user may interact with the user interface 816 by engaging the input/output devices 808. In some embodiments, the display 814 may be a touchscreen, where the user interface 816 is displayed on the touchscreen.

The display 814 may include a screen such as, for example, a Liquid Crystal Display (LCD) screen, a light-emitting diode (LED) screen, an organic LED (OLED) screen, a movable display, a projection, etc. In some embodiments, the display 814 may include a coder/decoder, also known as Codecs, to convert digital media data into analog signals. For example, the visual peripheral output device may include video Codecs, audio Codecs, or any other suitable type of Codec.

The optional location device 818 may be communicatively coupled to a location network and operable to receive position data from the location network. For example, in some embodiments, the location device 818 includes a GPS device that receives position data identifying a latitude and longitude from one or more satellites of a GPS constellation. As another example, in some embodiments, the location device 818 is a cellular device that receives location data from one or more localized cellular towers. Based on the position data, the computing device 800 may determine a local geographical area (e.g., town, city, state, etc.) of its position.

In some embodiments, the computing device 800 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 800 may be a computer, a workstation, a laptop, a server such as a cloud-based server, or any other suitable device. In some embodiments, the computing device 800 is a server that includes one or more processing units, such as one or more graphical processing units (GPUs), one or more central processing units (CPUs), and/or one or more processing cores. The computing device 800 may, in some embodiments, execute one or more virtual machines. In some embodiments, processing resources (e.g., capabilities) of the computing device 800 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Based on the training data of the training model, the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

It will be appreciated that disengagement candidates and engagement candidates determined by the incentive generating computing device 102 based on user data as disclosed herein, particularly on large datasets intended to be used with a disengagement evaluator 130 and/or an engagement evaluator 134 (or other components of the incentive generating computing device 102), is only possible with the aid of computer-assisted machine-learning algorithms and techniques. In some embodiments, machine learning processes are used to perform operations that cannot practically be performed by a human, either mentally or with assistance. It will be appreciated that a variety of machine learning techniques can be used alone or in combination to generate the disengagement candidates, engagement candidates, etc.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive first data and second data distinct from the first data;
determine, using a disengagement evaluator, disengagement scores for candidates in the first data;
select a set of candidates from the first data having disengagement scores above a disengagement threshold to form disengagement candidates;
determine, using an engagement evaluator, engagement scores for users, wherein the engagement scores are based on the disengagement candidates and the second data;
select a set of the users having engagement scores above an engagement threshold to form engagement candidates;
generate a notification for a user of the engagement candidates, wherein the notification includes an incentive for user interaction; and
transmit the notification to a computing device associated with the user of the engagement candidates.

2. The system of claim 1, wherein the engagement threshold is a first engagement threshold, the engagement candidates are first engagement candidates, and the instructions, when executed, further cause the processor to:
select another set of the users having engagement scores above a second engagement threshold to form second engagement candidates, wherein the second engagement threshold is less than the first engagement threshold; and
forgo generating notifications for respective users of the second engagement candidates.

3. The system of claim 1, wherein:
the first data includes engagement data, interaction data, and profile data; and
the second data includes user data.

4. The system of claim 1, wherein transmitting the notification to the computing device of the user of the engagement candidates includes:
causing the computing device to present:
a first user interface element for interacting with the incentive, and
a second user interface element for requesting an additional incentive.

5. The system of claim 1, wherein the disengagement candidates include one or more of candidate interactions, candidate engagements, or candidate users.

6. The system of claim 1, wherein the instructions, when executed, cause the processor to:
train the engagement evaluator, wherein the engagement evaluator:
includes a first segment and a second segment; and
is trained through semi-supervised semi-teaching.

7. The system of claim 6, wherein training the engagement evaluator includes:
providing test data to the first segment of the engagement evaluator;
determining, by the first segment of the engagement evaluator, based on the test data:
a first set of test users satisfying a first engagement threshold,
a second set of test users satisfying a second engagement threshold, and
wherein the first set of test users and the second set of test users form inferred test data;
providing the inferred test data to the second segment of the engagement evaluator;
determining, by the second segment of the engagement evaluator, a loss based on the inferred test data; and
updating the first segment of the engagement evaluator using the loss.

8. A computer-implemented method, comprising:
receiving first data and second data distinct from the first data;
determining, using a disengagement evaluator, disengagement scores for candidates in the first data;
selecting a set of candidates from the first data having disengagement scores above a disengagement threshold to form disengagement candidates;
determining, using an engagement evaluator, engagement scores for users, wherein the engagement scores are based on the disengagement candidates and the second data;
selecting a set of the users having engagement scores above an engagement threshold to form engagement candidates;
generating a notification for a user of the engagement candidates, wherein the notification includes an incentive for user interaction; and
transmitting the notification to a computing device associated with the user of the engagement candidates.

9. The computer-implemented method of claim 8, wherein the engagement threshold is a first engagement threshold, the engagement candidates are first engagement candidates, and the computer-implemented method further comprises:
select another set of the users having engagement scores above a second engagement threshold to form second engagement candidates, wherein the second engagement threshold is less than the first engagement threshold; and
forgo generating notifications for respective users of the second engagement candidates.

10. The computer-implemented method of claim 8, wherein:
the first data includes engagement data, interaction data, and profile data; and
the second data includes user data.

11. The computer-implemented method of claim 8, wherein transmitting the notification to the computing device of the user of the engagement candidates includes:
causing the computing device to present:
a first user interface element for interacting with the incentive, and
a second user interface element for requesting an additional incentive.

12. The computer-implemented method of claim 8, wherein the disengagement candidates include one or more of candidate interactions, candidate engagements, or candidate users.

13. The computer-implemented method of claim 8, wherein the computer-implemented method further comprises:
training the engagement evaluator, wherein the engagement evaluator:
includes a first segment and a second segment; and
is trained through semi-supervised semi-teaching.

14. The computer-implemented method of claim 13, wherein training the engagement evaluator comprises:
providing test data to the first segment of the engagement evaluator;
determining, by the first segment of the engagement evaluator, based on the test data:
a first set of test users satisfying a first engagement threshold,
a second set of test users satisfying a second engagement threshold, and
wherein the first set of test users and the second set of test users form inferred test data;
providing the inferred test data to the second segment of the engagement evaluator;
determining, by the second segment of the engagement evaluator, a loss based on the inferred test data; and
updating the first segment of the engagement evaluator using the loss.

15. A non-transitory computer readable medium having instructions stored thereon, wherein the instructions, when executed by at least one processor, cause at least one device to perform operations comprising:
receiving first data and second data distinct from the first data;
determining, using a disengagement evaluator, disengagement scores for candidates in the first data;
selecting a set of candidates from the first data having disengagement scores above a disengagement threshold to form disengagement candidates;
determining, using an engagement evaluator, engagement scores for users, wherein the engagement scores are based on the disengagement candidates and the second data;
selecting a set of the users having engagement scores above an engagement threshold to form engagement candidates;
generating a notification for a user of the engagement candidates, wherein the notification includes an incentive for user interaction; and
transmitting the notification to a computing device associated with the user of the engagement candidates.

16. The non-transitory computer readable medium of claim 15, wherein the engagement threshold is a first engagement threshold, the engagement candidates are first engagement candidates, and the instructions, when executed by the at least one processor, cause the at least one device to further perform operations comprising:
selecting another set of the users having engagement scores above a second engagement threshold to form second engagement candidates, wherein the second engagement threshold is less than the first engagement threshold; and
forgoing generating notifications for respective users of the second engagement candidates.

17. The non-transitory computer readable medium of claim 15, wherein:
the first data includes engagement data, interaction data, and profile data; and
the second data includes user data.

18. The non-transitory computer readable medium of claim 15, wherein transmitting the notification to the computing device of the user of the engagement candidates includes:
causing the computing device to present:
a first user interface element for interacting with the incentive, and
a second user interface element for requesting an additional incentive.

19. The non-transitory computer readable medium of claim 15, wherein the disengagement candidates include one or more of candidate interactions, candidate engagements, or candidate users.

20. The non-transitory computer readable medium of claim 15, wherein the instructions, when executed by the at least one processor, cause the at least one device to further perform operations comprising:
training the engagement evaluator, wherein the engagement evaluator:
includes a first segment and a second segment; and
is trained through semi-supervised semi-teaching.
